(19) United States
(12) Patent Application Publication
(10) Pub. No.: US 2006/0017801 A1
(43) Pub. Date: Jan. 26, 2006

(54) Image recording apparatus

(75) Inventors: Yoichi Suzuki, Kanagawa (JP); Yoshinori Morimoto, Kanagawa (JP); Kenichi Saito, Kanagawa (JP)

Correspondence Address: BIRCH STEWART KOLASCH & BIRCH, PO BOX 747, FALLS CHURCH, VA, 22040-0747, US

(73) Assignee: Fuji Photo Film Co., Ltd., Minami-Ashigara-shi (JP)

(21) Appl. No.: 11/178,385

(22) Filed: Jul. 12, 2005

(30) Foreign Application Priority Data
Jul. 14, 2004 (JP) 2004-206941

(51) Int. Cl. B41J 2/435

(52) U.S. Cl. 347/248

(57) ABSTRACT

In an image recording apparatus, an exposure control circuit includes: a clock selecting circuit for respectively outputting different scanning clocks corresponding to each laser light sources based on information on oscillation wavelengths of laser beams; and laser driving circuits for operating synchronously with the respective scanning clocks to output modulation signals corresponding to image data for each of the laser light sources. The clock selecting circuit selectively output one scanning clock among a plurality of scanning clocks with different oscillation frequencies which are previously prepared based on the information on the oscillation wavelengths of the plurality of laser beams with respect to at least one laser light source among the plurality of laser light sources.

This application claims priority on Japanese patent application No. 2004-206941, the entire contents of which are hereby incorporated by reference. In addition, the entire contents of literatures cited in this specification are incorporated by reference.

### BACKGROUND OF THE INVENTION

The present invention relates to an image recording apparatus which adopts a multi-beam scanning optical system and serves to record an image corresponding to image data on a recording medium using a plurality of laser light sources for emitting laser beams as an exposure light source.

In an image recording apparatus which adopts a multi-beam scanning optical system and serves to record an image using a plurality of laser light sources, chromatic aberrations such as a chromatic aberration of magnification occur due to a difference between oscillation wavelengths of laser beams (light beams) emitted from the respective laser light sources.

For this reason, in order to suppress the chromatic aberrations in the image recording apparatus adopting the multi-beam scanning optical system, it has been proposed to select glass materials of optical lenses, or as disclosed in JP 10-149430 A, JP 11-70698 A, and JP 11-88619 A, it has been proposed that a plurality of laser light sources are controlled using different scanning clocks to thereby carry out the correction.

A technique disclosed in JP 10-149430 A described above relates to a construction of an optical system in an optical scanning apparatus for executing a processing of, for example, applying a plurality of laser beams with different wavelengths to an object of the scanning to scan the object of the scanning with a plurality of laser beams, thereby recording information read through the scanning operation. In the technique disclosed in JP 10-149430 A, emission time and emission timing when respective laser beams are emitted from respective green, blue, and red semiconductor lasers are controlled, thereby compensating for the chromatic aberration of magnification.

In addition, a technique disclosed in JP 11-70698 A relates to a color printer using a plurality of laser light sources for emitting respective light beams with different wavelengths. In the technique disclosed in JP 11-70698 A, three light beams are modulated at different three data speeds, thereby correcting the transverse chromatic aberration of an f-θ lens.

In addition, a technique disclosed in JP 11-88619 A relates to an image exposing apparatus for applying three or more kinds of emitted light beams with different wavelengths to a photosensitive material based on image data to form a latent image on the photosensitive material. In the technique disclosed in JP 11-88619 A, the scanning lengths on an exposure surface of the two kinds of emitted light beams are made substantially equal to each other by a scanning lens permitting the characteristics of the chromatic aberrations of the two kinds of emitted light beams to be substantially equal to each other. Moreover, the frequency of a scanning clock for the two kinds of emitted light beams and the frequency of a scanning clock for the emitted light beam other than the two kinds of emitted light beams are determined so that the scanning length on the exposure surface of the two kinds of emitted light beams and the scanning length on the exposure surface of the emitted light beam other than the two kinds of emitted light beams become substantially equal to each other.

For example, in the application of the photographic print in which an image is recorded on a photographic paper, the above-mentioned multi-beam scanning optical system is used in the exposing unit. Taking the spectral sensitivity of the photographic paper into consideration, the exposure needs to be carried out using the red, green, and blue laser light sources as the exposure light source in the photographic print. However, since the laser beams emitted from the laser light sources have wide oscillation wavelengths in the visible range, it is very difficult to suppress the chromatic aberration of magnification up to about several tens of μm.

In addition, some laser light sources have large dispersion in oscillation wavelength. For example, there exists the laser light source having oscillation wavelength dispersion even in the range of about ±5 to 10 nm. However, when the selected laser light source is used, this leads to cost-up. On the other hand, when the laser light source having the large dispersion in oscillation wavelength is used, there occurs a problem that the optical design for correcting the chromatic aberration of magnification becomes very difficult, or the system becomes expensive since special glass materials need to be used for the optical lenses.

### SUMMARY OF THE INVENTION

The present invention has been made in order to solve the above-mentioned problems in the prior art. Therefore, it is an object of the present invention to provide an image recording apparatus which is capable of suppressing chromatic aberrations irrespective of optical lenses, even when a laser light source having large dispersion in oscillation wavelength is used, to thereby reduce cost.

In order to attain the above-mentioned object, the present invention provides an image recording apparatus including: an exposure control circuit for controlling exposure corresponding to image data; and an exposing unit for imaging a plurality of laser beams with different oscillation wavelengths which are modulated with respective modulation signals outputted from the exposure control circuit to be emitted from a plurality of laser light sources, respectively, on a recording medium through optical lenses, thereby recording an image corresponding to the image data on the recording medium, wherein

the exposure control circuit includes: a clock selecting circuit for outputting different scanning clocks corresponding to each of the plurality of laser light sources based on information on the oscillation wavelengths of the plurality of laser beams; and laser driving circuits operating synchronously with the scanning clocks to output the respective modulation signals corresponding to the image data for the respective laser light sources, and wherein

the clock selecting circuit selectively output one scanning clock among a plurality of scanning clocks with different oscillation frequencies which are previously prepared based on the information on the oscillation wavelengths of the plurality of laser beams with respect to at least one laser light source among the plurality of laser light sources.

Here, it is preferable that the clock selecting circuit of the exposure control circuit selectively outputs the one scanning clock based on information on oscillation wavelength of a laser beam supplied from outside.

In addition, it is preferable that the exposing unit includes an information recording circuit in which the information on the oscillation wavelengths of the plurality of laser beams is recorded, and the clock selecting circuit of the exposure control circuit selectively outputs the one scanning clock based on the information on the oscillation wavelengths of the plurality of laser beams supplied from the information recording circuit.

Here, it is preferable that the information recording circuit is singly provided corresponding to the plurality of laser light sources, or the information recording circuit is provided in correspondence with each of the plurality of laser light sources. In addition, it is preferable that the information recording circuit is a ROM in which the information on the oscillation wavelengths of the plurality of laser beams is recorded.

In addition, it is preferable that the exposing unit include a wavelength detector for detecting the oscillation wavelengths of the plurality of laser beams, and the clock selecting circuit of the exposure control circuit selectively outputs the one scanning clock based on the information on the oscillation wavelengths of the plurality of laser beams supplied from the wavelength detector.

Here, it is preferable that the wavelength detector is provided in correspondence with each of the plurality of laser light sources.

In addition, at least one of the plurality of laser light sources is preferably a semiconductor laser for outputting a blue laser beam having an oscillation wavelength of 480 nm or shorter.

Further, the image recording apparatus is preferably a digital photographic printer for recording an image corresponding to the image data onto a photographic paper as the recording medium.

Here, the image data is preferably image data which is obtained by photoelectrically reading an image captured on a photographic film, or image data of an image which is captured with a digital camera.

### BRIEF DESCRIPTION OF THE DRAWINGS

FIG. 1 is a schematic view showing a construction of an exposing unit of an image recording apparatus according to an embodiment of the present invention;

FIG. 2 is a schematic view showing a positional relationship among optical elements disposed on a downstream side with respect to an fθ lens 42 in the exposing unit shown in FIG. 1;

FIG. 3 is a block diagram showing a schematic configuration of the exposing unit and an exposure control circuit of the image recording apparatus according to an embodiment of the present invention;

FIG. 4 is a schematic view of an example of an image to be recorded; and

FIGS. 5A and 5B are schematic views each showing a relationship between a scanning clock and recorded pixels when the image to be recorded shown in FIG. 4 is recorded.

### DETAILED DESCRIPTION OF THE PREFERRED EMBODIMENTS

An image recording apparatus according to the present invention will hereinafter be described in detail based on preferred embodiments shown in the accompanying drawings.

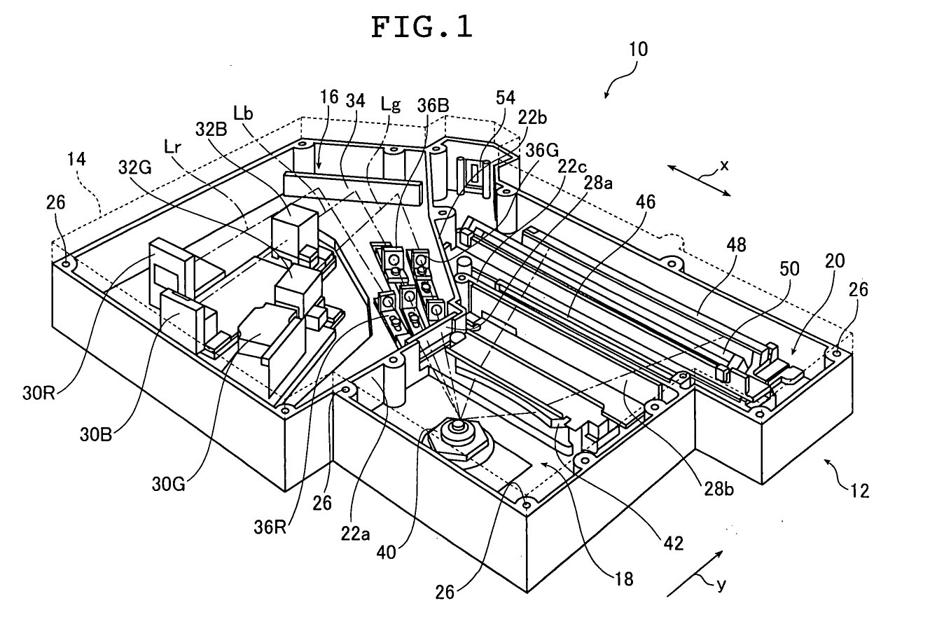

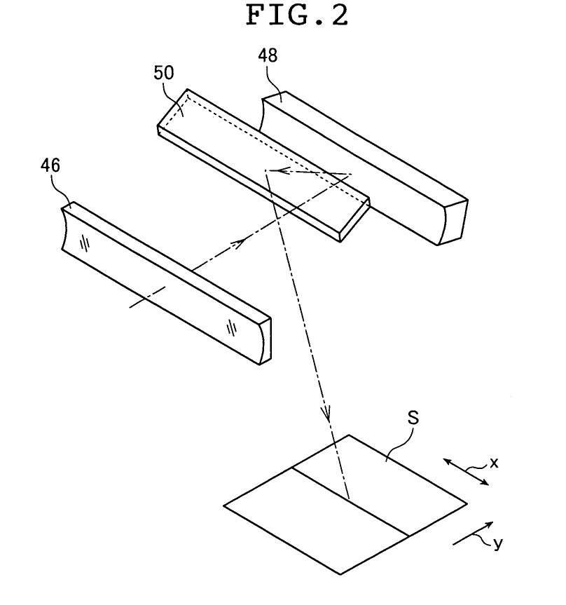

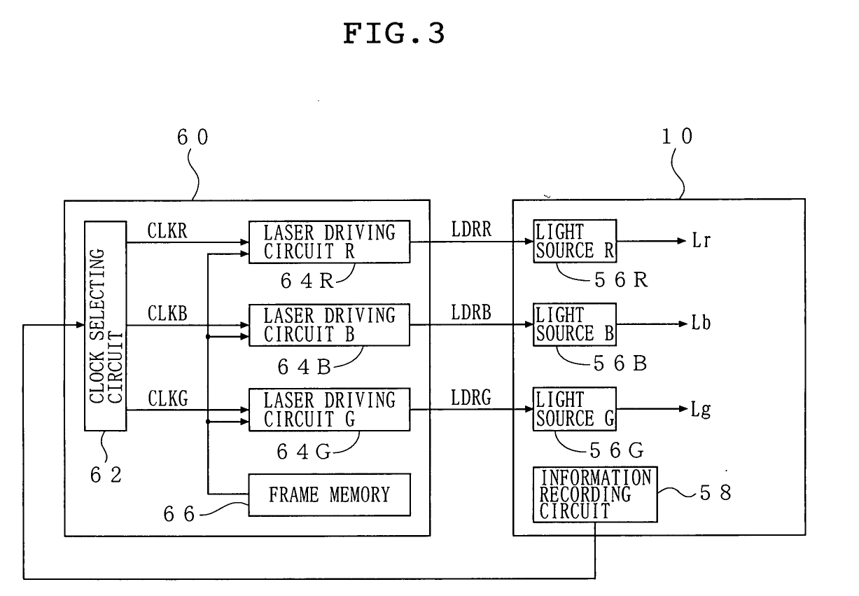

As shown in FIG. 3, an image recording apparatus according to the present invention includes an exposing unit 10 and an exposure control circuit 60. Firstly, with reference to FIGS. 1 and 2, the details of the exposing unit 10 used in the image recording apparatus according to the present invention will be described. FIG. 1 is a schematic view showing a construction of an exposing unit of the image recording apparatus according to the embodiment of the present invention, and FIG. 2 is a schematic view showing a positional relationship among optical elements disposed on a downstream side with respect to an fθ lens 42 in the exposing unit shown in FIG. 1.

In an exposing unit 10 shown in FIG. 1, three light beams (laser beams) L (Lr, Lb, and Lg) which correspond to R (Red) exposure, B (Blue) exposure, and G (Green) exposure and which are modulated in correspondence to an image to be recorded (image data) are deflected in a main scanning direction (a direction indicated by an arrow x in FIG. 1) to be made incident to a predetermined recording position (exposure position), whereby a photosensitive material S (see FIG. 2) which is conveyed in a sub scanning direction (a direction indicated by an arrow y in FIG. 1) nearly perpendicularly intersecting the main scanning direction is two-dimensionally scanned and exposed to the three light beams L to record an image.

Such an exposing unit 10 is utilized, for example, in a printer (printing apparatus) of a digital photographing system which produces a photographic print from image data obtained by photoelectrically reading an image photographed on a photographic film, image data of an image which is photographed with a digital camera, or the like.

In the example shown in FIG. 1, the exposing unit 10 includes a frame 12 as a chassis having one open face, a cover 14 (represented by a dotted line in FIG. 1) for covering the open face (upper face) of the frame 12, and various kinds of optical elements which are disposed and fixed at predetermined positions in the frame 12.

In the example shown in FIG. 1, the frame 12 is the chassis operating as an optical plate which is provided in a light beam scanning optical system and which serves to accommodate/fix the various optical elements constituting the light beam scanning optical system. In the example shown in FIG. 1, the frame 12 is made, for example, of an aluminum alloy, and its inside is roughly separated through partition walls 22 (22a, 22b, and 22c) into a light source portion 16, a light deflecting portion 18, and an emission portion 20.

A cutout is formed in a portion of the partition wall 22a corresponding in position to optical paths of the light beams L, and a transparent window member 28a is fixed to the cutout. Similarly, a cutout is formed in a portion of the partition wall 22c as well, corresponding in position to the optical paths of the light beams L, except for an upper portion of the partition wall 22c. Also a transparent window member 28b is fixed to the cutout. The frame 12 is covered with the cover 14, and the cover 14 is fixed to the frame 12 by screwing in a predetermined number of tapped holes 26 formed near an external wall and the partition walls 22.

A light source 30R for emitting the light beam Lr with which the R exposure is carried out, a light source 30B for emitting the light beam Lb with which the B exposure is carried out, a light source 30G for emitting the light beam Lg with which the G exposure is carried out, an acoustic-optical modulator (AOM) 32B for modulating the light beam Lb, an AOM 32G for modulating the light beam Lg, a mirror 34 for reflecting the light beams L (Lb, Lg, Lr), light amount/beam focus adjusting means 36R for adjusting a light amount and a beam focus (beam diameter) of light beam Lr, light amount/beam focus adjusting means 36B for adjusting a light amount and a beam focus of light beam Lb, and light amount/beam focus adjusting means 36G for adjusting a light amount and a beam focus of light beam Lg are disposed in the light source portion 16 provided inside the frame 12 in the example shown in FIG. 1.

In the example shown in FIG. 1, each of the light source 30R of the light beam Lr and the light source 30B of the light beam Lb is a laser diode (LD, i.e., semiconductor laser). The light source 30G of the light beam Lg is obtained by combining the LD and a second harmonics generation element (SHG element, i.e., wavelength conversion element) and emits the light beam Lg having a ½ wavelength (second harmonic) of a wavelength of the light beam emitted from the LD. In addition, the light beam Lr is modulated in correspondence to image data through direct modulation operation for modulating and driving the light source 30R, and the light beams Lb and Lg are modulated in correspondence to the image data by the AOMs 32B and 32G, respectively.

In addition, a polygon mirror 40 and an fθ lens (scanning lens) 42 are disposed in the light deflecting portion 18.

Moreover, a cylindrical lens 46, a cylindrical mirror 48, and a mirror 50 for downward reflecting a light beam are disposed in the emission portion 20 to show a positional relationship shown in FIG. 2. The light beams L are obliquely reflected slightly upward by the cylindrical mirror 48, and are then reflected downward by the mirror 50 for downward reflecting a light beam. Note that the cylindrical lens 46 and the cylindrical mirror 48 constitute an optical face tangle error correcting system for the polygon mirror 40.

In addition, in order to determine a start-of-scan (SOS) position for the photosensitive material S, an optical sensor 54 for detecting the light beam Lr corresponding to the R exposure is disposed in the emission portion 20 in the frame 12.

The light beam Lr corresponding to the R exposure is modulated in correspondence to the image to be recorded (the image data of R) to be emitted from the light source 30R, reflected by the mirror 34, adjusted with its light amount and beam focus by the light amount/beam focus adjusting means 36R, and then transmitted through the window member 28a, thereby being made incident to the polygon mirror 40.

In addition, the light beam Lb corresponding to the B exposure is emitted from the light source 30B, modulated in correspondence to the image to be recorded (the image data of B) by the AOM 32B, reflected by the mirror 34, adjusted with its light amount and beam focus by the light amount/beam focus adjusting means 36B, and then transmitted through the window member 28a, thereby being made incident to the polygon mirror 40. Similarly, the light beam Lg corresponding to the G exposure is emitted from the light source 32G, modulated in correspondence to the image to be recorded (the image data of G) by the AOM 30G, reflected by the mirror 34, adjusted with its light amount and beam focus by the light amount/beam focus adjusting means 36G, and then transmitted through the window member 28a, thereby being made incident to the polygon mirror 40.

The light beams L (Lr, Lb, and Lg) are deflected in the main scanning direction by the polygon mirror 40 and are further adjusted by the fθ lens 42 so that the scanning speed is uniform. The light beams L which have passed through the fθ lens 42 are transmitted through the window portion 28b, pass through the cylindrical lens 46, and then are reflected by the cylindrical mirror 48, i.e., adjusted with their optical paths to correct the optical face tangle error, and are further reflected downward by the mirror 50 for downward reflecting a light beam to be made incident to the recording position (on the photosensitive material S).

In the exposing unit 10 in the example shown in FIG. 1, the three light beams L emitted from the light sources 30R, 30B, and 30G are made incident to the same point on the polygon mirror 40 to be deflected by the polygon mirror 40, and are then made incident to a predetermined recording position to form one and the same scanning line. Consequently, the light beams L travel through the optical paths which differ from each other in main scanning direction, but are approximately identical to each other in the sub scanning direction, to be made incident to the recording position (non-beam-synthesizing light beam scanning optics, more specifically, three-laser beam different-angle incidence optics or three-light source non-beam-synthesizing optics).

When an image is recorded, the light beam Lr corresponding to the R exposure is detected by the optical sensor 54, and the SOS recording position for the photosensitive material S is determined. In addition, the photosensitive material S (photographic printing paper) is conveyed in the sub scanning direction at a predetermined speed in the recording position. Thus, the photosensitive material S is two-dimensionally scanned and exposed with the light beams L deflected in the main scanning direction to record a latent image. The photosensitive material S having the latent image formed thereon is supplied to a processor (developing processor) (not shown). Then, the various processings such as color development, bleach fixing, washing, drying, and classification are executed in the processor.

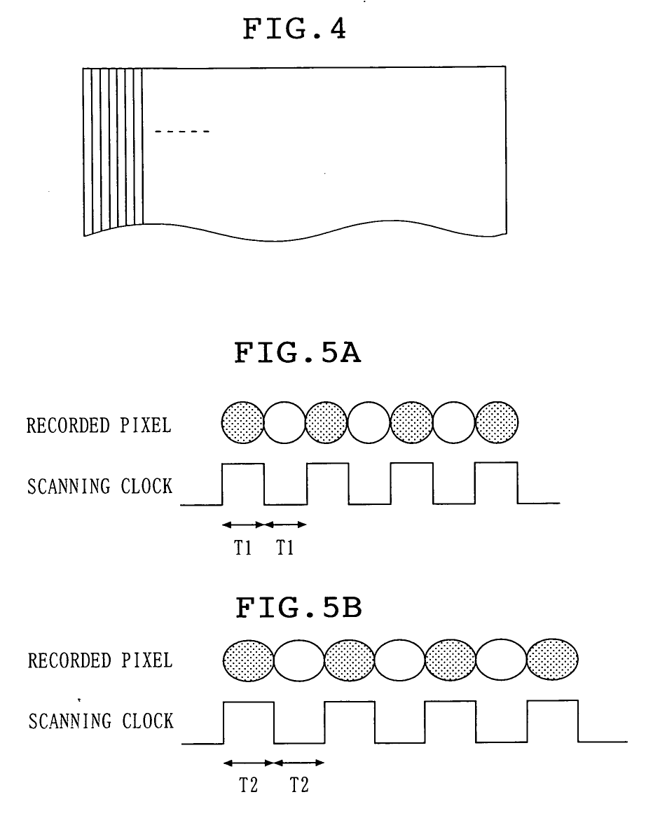

Next, with reference to FIGS. 3, 4, and 5A and 5B, an outline of the exposure control circuit 60 used in the image recording apparatus according to the present invention will be described. FIG. 3 is a block diagram showing a schematic configuration of the exposing unit and the exposure control circuit of the image recording apparatus according to the present invention. In addition, FIG. 4 is a schematic view of an example of an image to be recorded, and FIGS. 5A and 5B are schematic views each showing a relationship between a scanning clock and recorded pixels when the image to be recorded shown in FIG. 4 is recorded.

In the exposing unit 10 shown in FIG. 3, light sources 56R, 56B, and 56G conceptually represent the light sources 30R, 30B, and 30G, and the AOMs 32G and 32B shown in FIG. 1. That is, the light source 56R corresponds to the light source 30R. In addition, the light source 56B corresponds to the light source 30B and the AOM 32B, and the light source 56G corresponds to the light source 30G and the AOM 32G.

In this embodiment, for the sake of simplicity of description, the description will be here given on the assumption that the laser beams Lr, Lb, and Lg emitted from the respective light sources 56R, 56B, and 56G are modulated with respective modulation signals LDRR, LDRB, and LDRG, which are supplied from the exposure control circuit 60.

In the case of this embodiment, the light source 56R emits the red laser beam Lr with an oscillation wavelength of 655 nm to 665 nm which has been modulated with the modulation signal LDRR. In addition, the light source 56B emits the blue laser beam Lb with an oscillation wavelength of 435 nm to 445 nm which has been modulated with the modulation signal LDRB, and the light source 56G emits the green laser beam Lg with an oscillation wavelength of 532 nm which has been modulated with the modulation signal LDRG.

In addition, the exposing unit 10 includes an information recording circuit 58 in which the information on the oscillation wavelength of the laser beam is recorded. Any kind of read only memories (ROMs) or the like can be used as the information recording circuit 58. Further, the information on the oscillation wavelength can be obtained by actually measuring the oscillation wavelength of the laser beam, for example, in the same environment as that when an image is actually recorded in the image recording apparatus.

In the case of this embodiment, the information on the oscillation wavelength of the laser beam Lb emitted from the light source 56B is stored in the information recording circuit 58. Note that the information recording circuit 58 may be provided to the light sources 56R, 56B, and 56G, respectively.

On the other hand, the exposure control circuit 60 shown in FIG. 3 serves to control the exposure corresponding to the image data. The exposure control circuit 60 includes a clock selecting circuit 62, laser driving circuits 64R, 64B, and 64G, and a frame memory 66.

The frame memory 66 is a buffer in which the image data of the image to be recorded in the exposing unit 10 is temporarily stored. Any kinds of random access memories (RAMs) or the like can be used as the frame memory 66.

Then, the clock selecting circuit 62 outputs scanning clocks CLKR, CLKB, and CLKG for controlling the operations of the light sources 56R, 56B, and 56G (i.e., the laser driving circuits 64R, 64B, and 64G), respectively. The oscillation frequencies of the scanning clocks CLKR, CLKB, and CLKG are determined corresponding to the oscillation wavelengths of the laser beams Lr, Lb, and Lg so that the chromatic aberration of magnification due to the optical lenses used in the exposing unit 10 can be suppressed.

In the case of this embodiment, the scanning clocks having the respective oscillation frequencies which are previously determined corresponding to the respective oscillation wavelengths of the laser beams Lr and Lg are used as the scanning clocks CLKR and CLKG used in the laser driving circuits 64R and 64G, respectively. This reason is that even when the oscillation wavelengths of the laser beams Lr and Lg disperse, the actual occurrence situation of the chromatic aberration of magnification due to the optical lenses used in the exposing unit 10 hardly changes.

On the other hand, with respect to the oscillation frequency of the scanning clock CLKB used in the laser driving circuit 64B, the scanning clock CLKB with the oscillation frequency which is determined based on the information on the oscillation wavelength of the laser beam Lb supplied from the information recording circuit 58 is selectively outputted among a plurality of previously prepared scanning clocks CLKB with different oscillation frequencies. That is, the oscillation frequency of the scanning clock CLKB is changed corresponding to the oscillation wavelength of the laser light source Lb.

In the case of this embodiment, the oscillation wavelengths of the laser beam Lb are classified into five groups consisting of the oscillation wavelength of 435 to 437 nm, the oscillation wavelength of 437 to 439 nm, the oscillation wavelength of 439 to 441 nm, the oscillation wavelength of 441 to 443 nm, and the oscillation wavelength of 443 to 445 nm at intervals of 2 nm. The scanning clocks CLKB1 to CLKB5 having predetermined oscillation frequencies are prepared for the respective groups. Then, there is outputted one scanning clock which is selected among the scanning clocks CLKB1 to CLKB5 based on the information of the oscillation wavelength of the laser beam Lb.

Note that the oscillation wavelengths of the laser beam Lb may be classified into two or more groups. In addition, the scanning clock is not limited only to the scanning clock CLKB. Thus, a constitution may be adopted in which one scanning clock which is selected among a plurality of previously prepared scanning clocks with different oscillation frequencies is outputted based on the information of the oscillation wavelength of the laser beam with respect to the scanning clock of at least one laser beam having large dispersion in oscillation wavelength.

Further, the laser driving circuits 64R, 64B, and 64G serve to output the modulation signals LDRR, LDRB, and LDRG corresponding to the image data supplied from the frame memory 66 to thereby drive the laser light sources 56R, 56B, and 56G, respectively. The laser driving circuits 64R, 64B, and 64G operate synchronously with the scanning clocks CLKR, CLKB, and CLKG supplied from the clock selecting circuits 62R, 62B, and 62G, respectively.

While an image is recorded, the laser driving circuits 64R, 64B, and 64G operate synchronously with the scanning clocks CLKR, CLKB, and CLKG supplied from the clock selecting circuit 62 to thereby output the modulation signals LDRR, LDRB, and LDRG corresponding to the image data, respectively. Then, the laser beams Lr, Lb, and Lg modulated with the modulation signals LDRR, LDRB, and LDRG are outputted from the light sources 56R, 56B, and 56G, respectively.

Here, when an image having a vertical-striped pattern as shown in FIG. 4 is recorded, as shown in FIGS. 5A and 5B, for example, a black pixel and a white pixel are recorded every two pixels. FIGS. 5A and 5B each show states of the recorded pixels in cases where the vertical-stripped pattern shown in FIG. 4 is recorded using the modulated laser beams L when the widths of the scanning clocks CLK are set as T1 and T2 (T1<T2). As shown in FIGS. 5A and 5B, the oscillation frequency of the scanning clock CLK is changed, thereby making it possible to adjust a transverse size (position) of the pixel to be recorded.

That is, the oscillation frequency of the scanning clock CLK is suitably set corresponding to the occurrence state of the chromatic aberration of magnification due to the optical lenses used in the exposing unit 10, thereby making it possible to suppress the chromatic aberration of magnification. Consequently, the use of the optical lenses made of special glass materials can be suppressed to a minimum. Moreover, it is unnecessary to select the laser light source to be used. That is, since even the laser light source having the large dispersion in the oscillation wavelength can be used, it is possible to reduce the cost of the system.

In addition, the information recording circuit 58 in which the information on the oscillation wavelength of the laser beam Lb is previously stored is provided in the exposing unit 10. Hence, even when the exposing unit 10 itself is exchanged for new one due to a failure or the like, the exposure control circuit 60 can automatically set the scanning clock suitable for the light source 56B by reading out the information on the oscillation wavelength of the laser beam Lb from the information recording circuit 58 provided in the newly exchanged exposing unit 10.

Note that the information recording circuit 58 in which the information on the oscillation wavelength of the laser beam Lb is previously stored is not a constituent element essential to the present invention. That is, a construction may also be adopted in which no information recording circuit 58 is provided in the exposing unit 10 and the information on the oscillation wavelength of the laser beam is supplied from the outside to the clock selecting circuit 62. Alternatively, a constitution may also be adopted in which a wavelength detector for detecting the oscillation wavelength of the laser beam is installed in the exposing unit 10 and the information on the oscillation wavelength of the laser beam detected by the wavelength detector is supplied to the clock selecting circuit 62.

In addition, while the above-mentioned embodiment has been described by giving an example of the oscillation wavelengths of the laser beams Lr, Lb, and Lg, the present invention is not intended to be limited thereto. For example, a laser beam with a wavelength of 470 nm to 480 nm may be used as the laser beam Lb in some cases. Further, as regards the image recording apparatus of the present invention, a digital photographic printer for recording an image on a photographic paper can be given as a preferred example. However, the present invention is not intended to be limited thereto. That is, the present invention can also be applied to the various image recording apparatuses using a plurality of laser light sources.

The present invention is basically described above.

While the image recording apparatus of the present invention has been described in detail hereinbefore, it is to be understood that the present invention is not intended to be limited to the above-mentioned embodiment, and thus the various improvements or modifications may be made without departing from the gist of the present invention.

What is claimed is:

1. An image recording apparatus including: an exposure control circuit for controlling exposure corresponding to image data; and an exposing unit for imaging a plurality of laser beams with different oscillation wavelengths which are modulated with respective modulation signals outputted from said exposure control circuit to be emitted from a plurality of laser light sources, respectively, on a recording medium through optical lenses, thereby recording an image corresponding to the image data on the recording medium, wherein
said exposure control circuit includes: a clock selecting circuit for outputting different scanning clocks corresponding to each of the plurality of laser light sources based on information on the oscillation wavelengths of the plurality of laser beams; and laser driving circuits operating synchronously with the scanning clocks to output the respective modulation signals corresponding to the image data for the respective laser light sources, and wherein
said clock selecting circuit selectively outputs one scanning clock among a plurality of scanning clocks with different oscillation frequencies which are previously prepared based on the information on the oscillation wavelengths of the plurality of laser beams with respect to at least one laser light source among the plurality of laser light sources.

2. The image recording apparatus according to claim 1, wherein said clock selecting circuit of said exposure control circuit selectively outputs the one scanning clock based on information on oscillation wavelength of a laser beam supplied from outside.

3. The image recording apparatus according to claim 1, wherein said exposing unit includes an information recording circuit in which the information on the oscillation wavelengths of the plurality of laser beams is recorded, and said clock selecting circuit of said exposure control circuit selectively outputs the one scanning clock based on the information on the oscillation wavelengths of the plurality of laser beams supplied from said information recording circuit.

4. The image recording apparatus according to claim 3, wherein said information recording circuit is singly provided corresponding to the plurality of laser light sources.

5. The image recording apparatus according to claim 3, wherein said information recording circuit is provided in correspondence with each of the plurality of laser light sources.

6. The image recording apparatus according to claim 3, wherein said information recording circuit is a ROM in which the information on the oscillation wavelengths of the plurality of laser beams is recorded.

7. The image recording apparatus according to claim 1, wherein said exposing unit includes a wavelength detector for detecting the oscillation wavelengths of the plurality of laser beams, and said clock selecting circuit of said exposure control circuit selectively outputs the one scanning clock based on the information on the oscillation wavelengths of the plurality of laser beams supplied from said wavelength detector.

8. The image recording apparatus according to claim 7, wherein said wavelength detector is provided in correspondence with each of the plurality of laser light sources.

9. The image recording apparatus according to claim 1, wherein at least one of the plurality of laser light sources is a semiconductor laser for outputting a blue laser beam having an oscillation wavelength of 480 nm or shorter.

10. The image recording apparatus according to claim 1, wherein said image recording apparatus is a digital photographic printer for recording an image corresponding to the image data onto a photographic paper as the recording medium.

11. The image recording apparatus according to claim 10, wherein the image data is image data which is obtained by photoelectrically reading an image captured on a photographic film, or image data of an image which is captured with a digital camera.
